(19) United States
(12) Patent Application Publication
(10) Pub. No.: US 2011/0173275 A1
(43) Pub. Date: Jul. 14, 2011

(54) Messaging Between Events

(76) Inventors: Ted Beers, Corvallis, OR (US); Michael D. Derocher, Albany, OR (US); Jon A. Brewster, Corvalis, OR (US); Lonnie D. Mandigo, Corvalis, OR (US); April S. Mitchell, Palo Alto, CA (US); Kenton O'hara, Bristol (GB)

(21) Appl. No.: 12/936,054

(22) PCT Filed: Apr. 30, 2008
(86) PCT No.: PCT/US08/62069

§ 371 Date: Dec. 10, 2010

(51) Int. Cl. G06F 15/16

(52) U.S. Cl. 709/206

(57) ABSTRACT

An event management system is configured to receive information from a person associated with a first event and provide a message to a second event that is associated with the first event.

### BACKGROUND

Collaboration event systems allow for collaboration between people in different locations. These systems allow participants to interact with one another through the use of audio and video equipment that provides real time audio and video communications. The process of connecting people across various locations may become complex, particularly where different groups of people desire to use part of the same collaboration event system for different collaboration events.

Participants of an event typically access a management system that allows events to be set up and configured. When one event overlaps with another event, the management system may perform a default action that does not result in an optimal resolution to the overlap. The limited abilities of a management system to handle overlaps may make the an event system less user friendly and result in frustration on the part of users, particularly given a wide range of overlaps and situations that can occur with participants of events.

### BRIEF DESCRIPTION OF THE DRAWINGS

FIG. 1 is a block diagrams illustrating one embodiment of a collaboration event system.

FIGS. 2A-2B are block diagrams illustrating embodiments of an event endpoint.

FIGS. 3A-3B are block diagrams illustrating embodiments of configurations of audio/video devices.

FIG. 4 is a block diagram illustrating one embodiment of events managed by an event management system.

FIG. 5 is a flow chart illustrating one embodiment of a method performed by an event management system.

FIGS. 6A-6C are block diagrams illustrating embodiments of communicating with a person who is associated with an event.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense.

As described herein, an event management system manages collaboration events such as video teleconferences. The event management system maintains registered event specifications for each collaboration event and dynamic event context information that describes the status of collaboration events relative to each other. The event management system uses the registered event specifications and the dynamic event context information to optimize the interaction between collaboration events. The event management system also includes event endpoint information and policies that describe relationships among endpoints and rules associated with endpoints and event attendees.

The event management system provides persons associated with events with the ability to send messages to other events. The event management system associates a person with an event using a registered event specification for the event and/or event endpoint information that associates the location of the person with the event. The event management system associates the event with another event based on an overlap between the events or other criteria. Using the associations and event policies, the event management system causes appropriate messages to be exchanged between the events.

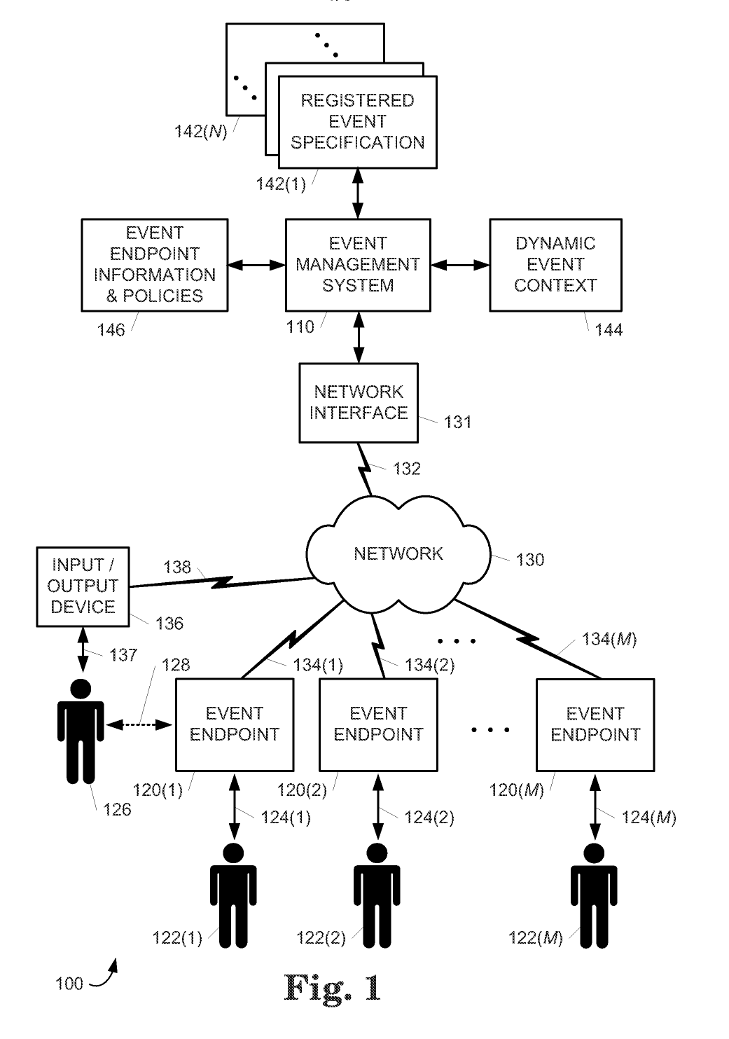

FIG. 1 is a block diagrams illustrating one embodiment of a collaboration event system 100. Collaboration event system 100 includes an event management system 110, a set of event endpoints 120(1)-120(M), and a network 130 that interconnects event management system 110 and event endpoints 120.

Collaboration event system 100 is configured to create and host collaboration events. A collaboration event is an activity with experiential relevance to people, possessing an extension in time and location. Examples of a collaboration event (hereafter “event”) include telepresence videoconferences and meetings conducted using collaboration studio such as a “Halo studio” offered by Hewlett-Packard Co. For each event, collaboration event system 100 exchanges a selected set of A/V media streams 124(1)-124(M) between a selected set or subset of event endpoints 120(1)-120(M).

An event includes a set of collaboration system topologies, each of which include a set or subset of event endpoints 120(1)-120(M). An event also includes a registered event specification 142 that specifies information such as a unique identity token, a purpose, a list of event attendees, a list of event resources, contact information of a host of the event, a priority of the event, start and end dates and times, and/or an event duration. Event resources may include event endpoints 120, physical locations (e.g., a collaboration studio or conference room), input/output devices 136 (e.g., interactive touchpoints), and attendees 122.

The collaborative event may take place in two or more locations (e.g., different cities) that each have an event endpoint 120 to connect a set of one or more attendees 122 or media resources in each of the locations. Cameras and microphones, for example, may capture video and audio from one or more of the locations (i.e., at one endpoint) and the video and audio may be output using one or more display devices and speakers, for example, at one or more other locations (i.e., one or more other endpoints). In addition, various types of pre-recorded NV data, such as content from a DVD, may be transported to one or more of the locations where it may be output using a display device or speakers, for example. One or more locations of the collaborative event may include arrangements of office furniture (e.g., office chairs and a conference table) and A/V gear to provide persons with gaze awareness and a full immersion feeling.

Event management system 110 is configured to initiate, execute, host, and optimize collaboration events using registered event specifications 142(1)-142(N), dynamic event context 144, and event endpoint information and policies 146. Each event is registered with event management system 110, either in advance (i.e., scheduled ahead of time) or in real time (i.e., scheduled on an ad hoc basis), to create a registered event specification 142 for the event using any suitable device for accessing event management system 110 (e.g., an event endpoint 120 or an input/output device 136). Event management system 110 may reference and use each registered event specification 142 for various purposes including preparation for and execution of an event in accordance with the information in a registered event specification 142.

Dynamic event context 144 is real-time information that describes the status of events (e.g., in-progress, interrupted, extended, etc.), the status of events relative to each other (e.g., overlapping or not overlapping based on the start and end times of events), the status of event endpoints 120 and other media resources (e.g., available, reserved, in use or otherwise occupied, or unavailable), and the status of attendees 122 (e.g., checked-in at an event endpoint 120 or elsewhere or not checked-in along with any special privilege indicators or other attendee designations) for each event. Event management system 110 generates and maintains dynamic event context 144 to monitor and manage the real-time system status of collaboration event system 100.

Endpoint information and policies 146 describes the locations, topologies, configurations, and operation policies of event endpoints 120(1)-120(M). Event management system 110 accesses event endpoint information and policies 146 for use in configuring and optimizing collaboration events. Event management system 110 may also reference and use other system information such as the time of day in the process of managing collaboration events.

Each event endpoint 120(1)-120(M) provides a respective set of one or more attendees 122(1)-122(M) with a respective set of one or more audio and/or visual media streams 124(1)-124(M) using network 130. Each event endpoint 120 includes any suitable type, number, and combination of audio and/or visual input and/or output devices that are configured to generate, provide, and/or receive the respective set of media streams 124. Media streams 124 may each be any suitable combination of live or pre-recorded audio and/or video data that may be combined in any suitable way and output to any number of attendees 122 in any number of event endpoints 120 by collaboration event system 100. Each set of attendees 122(1)-122(M) includes one or more people where the number of people may stay the same, increase, or decrease during the course of an event. In addition, the set of event endpoints 120 for an event may stay the same, increase, or decrease during the course of an event.

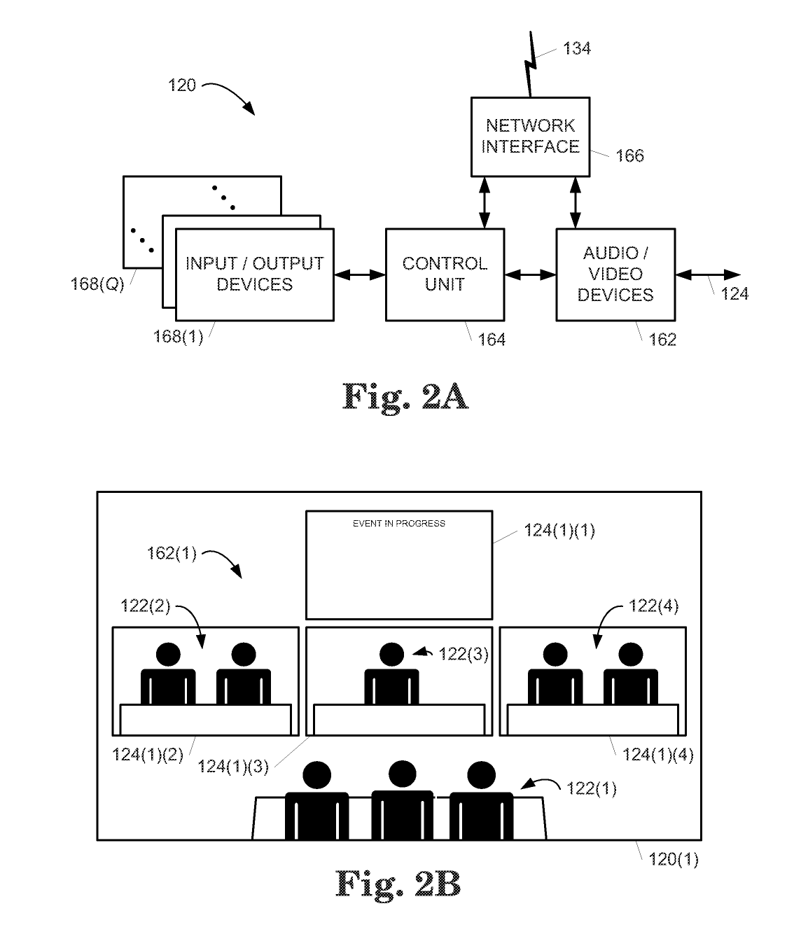

FIGS. 2A-2B are block diagrams illustrating embodiments of event endpoint 120. In the embodiment of FIG. 2A, event endpoint 120 includes a set of one or more audio and/or video (NV) devices 162, a control unit 164, a network interface 166 and a set of one or more input/output (I/O) devices 168(1)-168(Q).

A/V devices 162 includes any type, number, and combination of audio and/or video input and/or output devices. Examples of A/V input devices include microphones, still and video cameras, media players, and computer and storage systems. The A/V input devices capture, detect, receive or otherwise input live or pre-recorded media streams 124 and provide the input media streams 124 to control unit 164 and/or network interface 166. Examples of A/V output devices include speakers, headphones, headsets, media recorders, and display devices such as projectors, computer monitors, and televisions. The A/V output devices receive media streams from control unit 164 and/or network interface 166 and provide, display, play, or otherwise output live or pre-recorded media streams 124.

Control unit 164 manages the operation of event endpoint 120 by providing control signals and/or other information to and receiving control signals and/or other information from A/V devices 162, network interface 166 and input/output devices 168(1)-168(Q). In some embodiments, control unit 164 may perform processing on media streams received from A/V devices 162 and/or network interface 166 prior to the media streams being provided to network interface 166 or output by A/V devices 162. The processing may include coding or decoding media streams from one media and/or network format to another media and/or network format.

Network interface 166 includes any suitable type, number, and/or combination of network devices that allow event endpoint 120 to communicate with network 130 using network connection 134. Network interface 166 receives media streams across network connection 134 and provides the media streams to control unit 164 and/or A/V devices 162. Network interface 166 also receives media streams from control unit 164 and/or A/V devices 162 and provides the media streams to network 130 using network connection 134.

I/O devices 168(1)-168(Q) include any suitable type, number, and/or combination of input and/or output devices that allow attendees 122, administrators, or other persons to communicate with event endpoint 120. The communications may cause event endpoint 120 and/or collaboration event system 100 to perform functions indicated by attendees 122, administrators, or other persons. Examples of I/O devices 168 include interactive touchpoints, display screens, keyboards, and selection or navigation devices (e.g., a mouse, joystick, flywheel, or touchpad).

In other embodiments, the functionality of an A/V device 162 and an I/O device 168 may be included in a single unit such as a laptop computer. In addition, other embodiments may include A/V devices 162 but omit I/O devices 168 or may include I/O devices 168 but omit A/V devices 162.

FIG. 2B illustrates an embodiment of the operation of endpoint 120(1). Endpoint 120(1) provides attendees 122(1) who are present at endpoint 120(1) with media streams 124(1)(1)-124(1)(4) using any suitable type and/or combination of audio/video devices 162(1). Audio/video devices 162(1) are configured to allow for gaze awareness and a full immersion feeling for attendees 120(1).

In the example of FIG. 2B, media stream 124(1)(1) provides information about the event attended by attendees 122(1) (e.g., status information, notifications, configuration options, etc.) and media streams 124(1)(2)-124(1)(4) provide audio and video representations of by attendees 122(2)-122(4), respectively, who are present at event endpoints 120(2)-120(4), respectively. Attendees 122(1)-122(4) collectively represent the set of attendees who are present for the event illustrated by the example of FIG. 2B. In other embodiments, endpoint 120(1) may provide other numbers of media streams 124(1) to attendees 120(1) and may have other configurations of audio/video devices 162(1) relative to attendees 120(1).

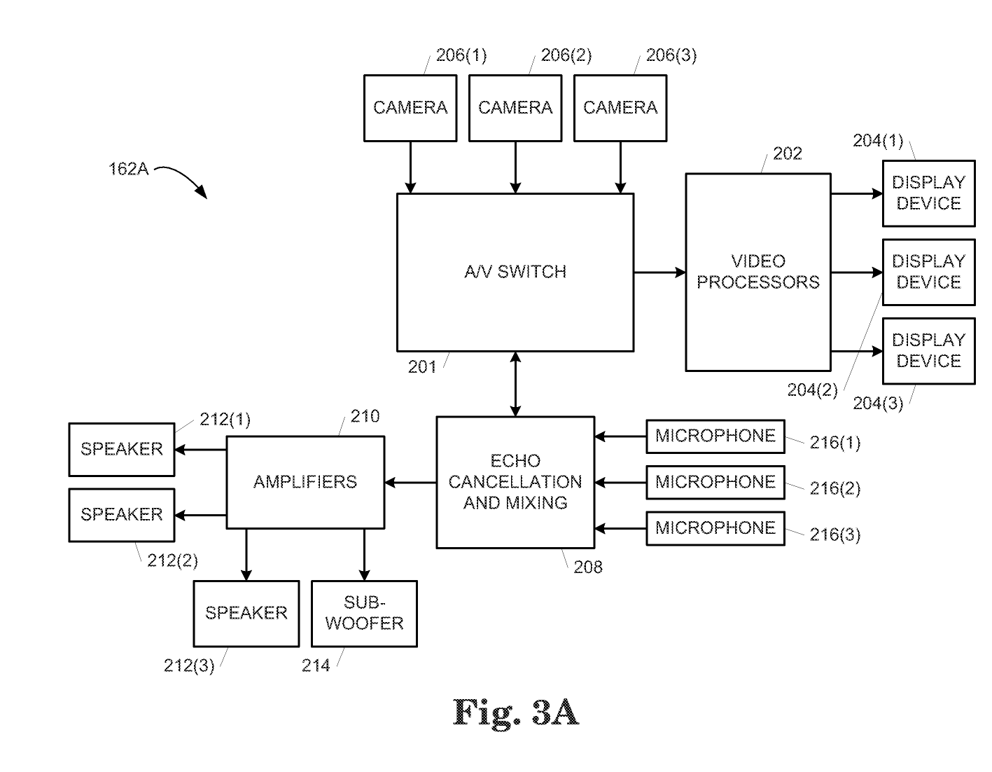

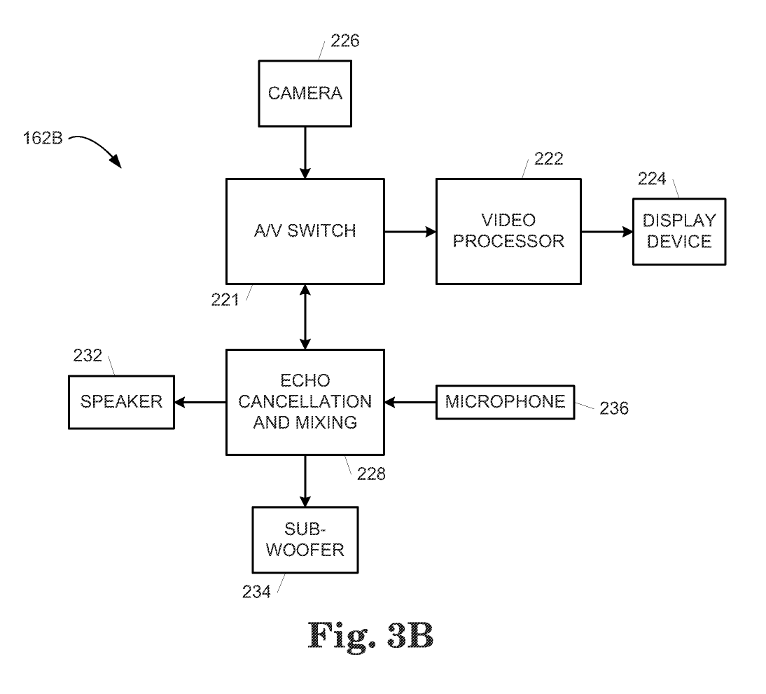

FIGS. 3A-3B are block diagrams illustrating embodiments of configurations of audio/video devices 162.

In one embodiment, A/V devices 162 includes integrated NV gear that forms a collaboration studio such as a “Halo studio” offered by Hewlett-Packard Co. as shown in the embodiment 162A of FIG. 3A. In the embodiment of FIG. 3A, video processors 202 provide video data from A/V switch 201 to display devices 204(1)-204(3), and display devices 204(1)-204(3) display the video data. Cameras 206(1)-206(3) capture video data and provide the video data to NV switch 201. An echo cancellation and mixing unit 208 mixes and processes audio data from A/V switch 201 and provides the processed audio data to amplifiers 210. Amplifiers 210 amplify the audio data and provide the audio data to speakers 212(1)-212(3) and sub-woofer 214. Speakers 212(1)-212(3) output the higher frequencies of the audio data, and sub-woofer 214 outputs the lower, bass frequencies of the audio data. Microphones 216(1)-216(3) capture audio data and provide the audio data to NV switch 201.

Display devices 204(1)-204(3) may be arranged in such a manner around a conference table and chairs to allow for gaze awareness and a full immersion feeling in one embodiment.

In another embodiment, NV devices 162 includes NV gear as shown in the embodiment 162B of FIG. 3B. In the embodiment of FIG. 3B, video processor 222 provides video data from NV switch 221 to display device 224, and display device 224 displays the video data. Camera 226 captures video data and provides the video data to NV switch 221. An echo cancellation and mixing unit 228 mixes and processes audio data from A/V switch 221 and provides the processed audio data to speaker 232 and sub-woofer 234. Speaker 232 outputs the higher frequencies of the audio data, and sub-woofer 234 outputs the lower, bass frequencies of the audio data. Microphone 236 captures audio data and provides the audio data to A/V switch 221 through echo cancellation and mixing unit 228.

Referring back to FIG. 1, network 130 may be any suitable type of network or combination of networks formed from any suitable number, type, and/or combination of network devices (not shown). The network devices may operate using any suitable network protocol or protocols and may connect to any suitable number of event endpoints 120 or other computer or storage systems. Network 130 may include any suitable combination of a secure networks (e.g., enterprise networks or corporate intranets) with limited and secure connections to other systems or unsecure networks with at least one unsecure connection to another system.

Network 130 may be a local, regional, or global network of any suitable network configuration that ranges from local point-to-point connections between event management system 110 and event endpoints 120 to a global array of connections that interconnect event management system 110 and event endpoints 120. Network 130 may be private or publicly available and include one or more connections to the Internet.

Network 130 may be designed specifically to optimize high bandwidth with low latency to be able to transport live, interactive, audio, video, and other data rich media streams. Network 130 may have a smallest link of 45 Mbps, in one embodiment, to avoid any significant serialization delay. Network 130 may also use a flat network topology to minimize latency. In order to keep a high quality end-user experience, network 130 may keep the total one-way latency between any event endpoints 120 to less than one-quarter of a second. This total latency may encompass all aspects of encoding/decoding, encapsulation/de-encapsulation, capture and presentation, filtering, processing, compression and decompression, image compositing, and transport latencies across the transmission path. As the contribution of each component of network 130 to overall latency decreases (as technology improves), the length of the “reach” of where different sites can be physically located may be increased.

To better preserve the shortest paths capable of reliable delivery with little packet loss, bandwidth and network resource mechanisms (not shown) may be used to insure high-quality sessions for the duration of the collaboration session. As most traffic streams are presumed to take place linking a pair or small number of event endpoints 120 together for any given session, event management system 110 may have little presumption of event pre-emption once authorized events commence. In some embodiments, longer latency and/or loss tolerant sessions may be provided over network 130. Such services may include directory, presence, messaging, credential verification, calibration, and time/name services for examples.

The interior of network 130 may concentrate on speedy delivery of traffic flows. Any access control, encryption/decryption and other proxy services, if needed, may occur at the edge of network 130 such as in event endpoints 120 and not the interior of network 130 in some embodiments. This design may make the core of the backbone of network 130 simpler to grow, maintain, stable, and very fast.

Event management system 110 connects to network 130 using a network interface 131 and a network connection 132, and event endpoints 120(1)-120(M) connect to network 130 using respective network connections 134(1)-134(M). Each network connection 132 and 134(1)-134(M) may include any suitable type, number, and/or combination of wired or wireless network connections. For example, network connections 132 and 134(1)-134(M) may each be a leased line (i.e., a T3, optical, cable, or wireless high speed link) which provides a large data pipe to and from event management system 110, event endpoints 120(1)-120(M), and input/output device 136, respectively.

Input/output (I/O) device 136 may be any suitable type of device (e.g., a portable or non-portable device such as an interactive touchpoint, a computer, a cell phone, a media player, or a personal digital assistant) configured to communicate with event management system 110. I/O device 136 is configured to receive inputs from a person 126 and/or provide outputs to person 126 as indicated by an arrow 137. The outputs may include audio and/or video outputs. I/O device 136 connects to network 130 using any suitable wired or wireless network connection 138. I/O device 136 may be omitted in some embodiments.

In operation, event management system 110 initiates, executes, hosts, and optimizes collaboration events using registered event specifications 142(1)-142(N), dynamic event context 144, and event endpoint information and policies 146.

Event management system 110 initiates execution of an event by allocating resources for creating a real-time representation of the event according to the registered event specification 142 of the event to optimize the experience of attendees 122. The allocated resources include the set or a subset of event endpoints 120 as indicated by the registered event specification 142. Event management system 110 continues execution of the event with changes to the topology of the event (e.g., the addition or removal of event endpoints 120 during the event) to maintain and optimize the experience of attendees 122 and ends as dictated by the registered event specification 142 or by external inputs (e.g., from an attendee 122). During execution, event management system 110 may describe an event as being “in-progress”.

In preparation for event execution (i.e., during event preparation) and during event execution, certain activities may be performed by event resources or event management system 110 that impact the management of the event, such as an attendee 122 checking in at an endpoint location, an input/output device associated with an endpoint, or another location. During the course of the lifecycle of an event, additional related artifacts may be added to the event, such as an archive of the execution of the event.

Event management system 110 optimizes event preparation and event execution for each registered event that requires various resources including those resources whose states may impact event preparation and execution. The optimization accounts for resources that may be in use by one or more in-progress events, resources that may be unavailable (e.g., requested for use by another event or out of service), key event attendees 122 that are missing, and other critical event information. Event management system 110 also optimizes event execution for in-progress events by preventing unwanted disruption of an event using resources required by the registered event and by handling requests for resources made by other events.

Event management system 110 performs the optimization using registered event specifications 142 for all related events including the primary event being prepared and other events in progress that are consuming needed resources and dynamic event context information 144 which includes information about event resources (e.g., resources used by other in-progress events and other status information about needed resources). Event management system 110 may also perform the optimization using information provided by attendees, administrators, and/or other persons via I/O devices 168 and/or 136 associated with the event in progress and the registered events and event endpoint information and policies 146. Event endpoint information and policies 146 includes information about the physical and assigned relationships among resources, including relationship information about event endpoints 120 and I/O devices 168 and/or 136, policies regarding the management of shared resources to facilitate optimal event execution, and principles governing the systems behaviors in consideration of the multitude of registered and dynamic information.

Using inputs from registered event specifications 142, dynamic event context information 144, I/O devices 168 and/or 136, and event endpoint information and policies 146, event management system 110 applies event optimization policies to interact with an in-progress event, with related resources such as endpoints 120, and with related input/output devices 168 and/or 136. In doing so, event management system 110 optimizes the experience of attendees 122 such as by event preparation and creating a plan for execution when an overlap is detected between two or more events.

As used herein, the term overlap refers to a commonality of resources between two or more events that may prevent one or more of the events from proceeding as currently defined by the respective registered event specifications 142 for the one or more events. The commonality may be an event endpoint or endpoints 120, an event attendee 122, an event resource (e.g., A/V equipment), or at least a portion of network 130 or network interfaces and connections 132 or 134, for example, where the commonality is not conducive to being used by two or more events at the same time or close to the same time.

Event management system 110 provides a communication pathway between events using network interface 131 and network connection 132 to allow attendees or other interested persons of one event to interact with attendees or other interested persons of another event. Event management system 110 may use the communication pathway in instances where two or more events specify one or more common resources (i.e., overlap) to allow the attendees or other interested parties of the events to negotiate the use of the resources. The communication pathways may extend beyond endpoints 120 to hallways or vestibules outside of or nearby endpoints 120 or other locations remotely located from endpoints 120.

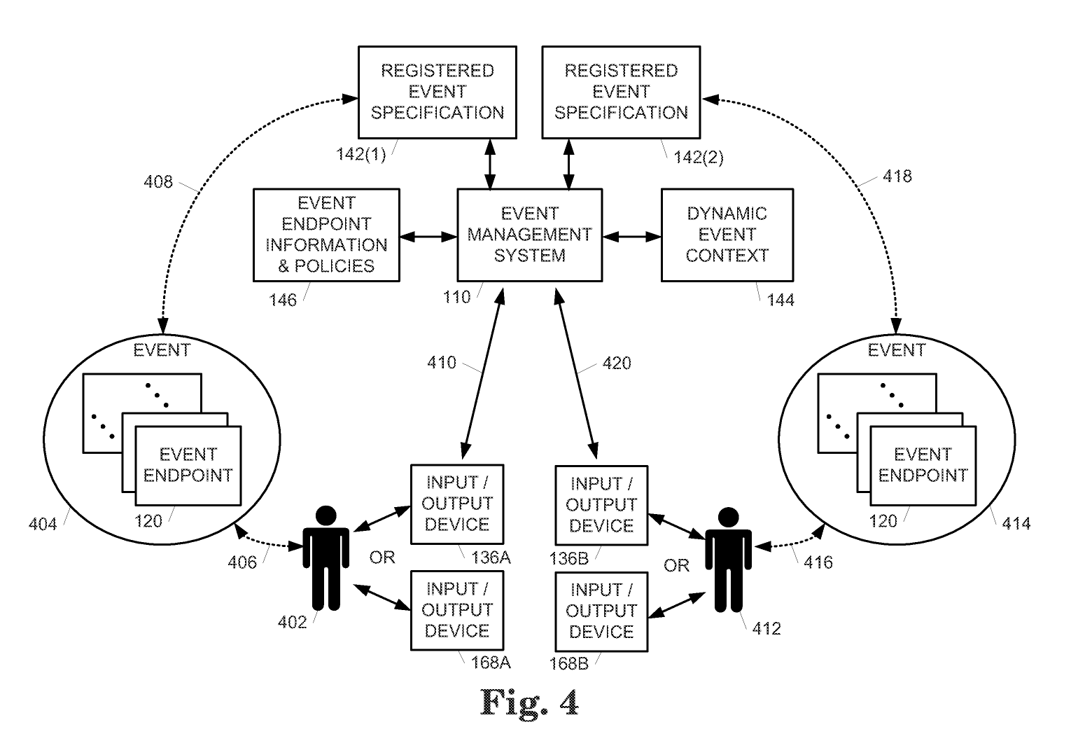

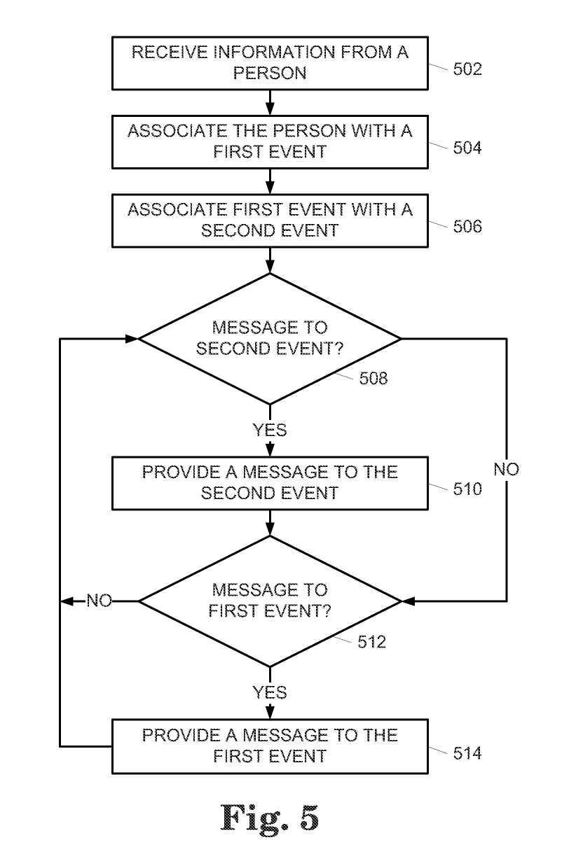

Event management system 110 provides persons associated with events with the ability to send messages to other events. Event management system 110 associates a person (e.g., person 126 or an attendee 122) with an event using a registered event specification 142 for the event and/or event endpoint information and policies 146 that associate the location of the person with the event. Event management system 110 associates the event of the person with another event based on an overlap between the events or other criteria. Using the associations and event endpoint information and policies 146, event management system 110 causes appropriate messages to be exchanged between the events as shown in the embodiments of FIGS. 4 and 5.

FIG. 4 is a block diagram illustrating one embodiment of events 404 and 414 managed by event management system 110. In the example of FIG. 4, a person 402 is associated with event 404 as indicated by an arrow 406, and a person 412 is associated with event 414 as indicated by an arrow 416. Events 404 and 414 include are described by registered event specifications 142(1) and 142(2), respectively, as indicated by arrows 408 and 418, respectively. During events 404 and 414, respective sets of event endpoints 120 provide respective sets of media streams 124 to respective sets of attendees 122 as specified by registered event specifications 142(1) and 142(2), respectively.

Persons 402 and 412 may be associated with events 404 and 414 in various ways. For example, persons 402 and/or 412 may be organizers or attendees of events 404 and/or 414, respectively, as identified by registered event specifications 142(1) and/or 142(2) for events 404 and/or 414, respectively. Person 402 and/or 412 may also be parties acting on behalf of organizers or attendees identified by registered event specifications 142(1) and/or 142(2) for events 404 and/or 414, respectively. Persons 402 and/or 412 may further be attempting to register for events 404 and/or 414, respectively, by adding their names to registered event specifications 142(1) and/or 142(2) for events 404 and/or 414, respectively. In addition, persons 402 and/or 412 may be associated with events 404 and/or 414 in response to event management system 110 detecting that persons 402 and/or 412 are located at or near event endpoints 120 for events 404 and/or 414, respectively.

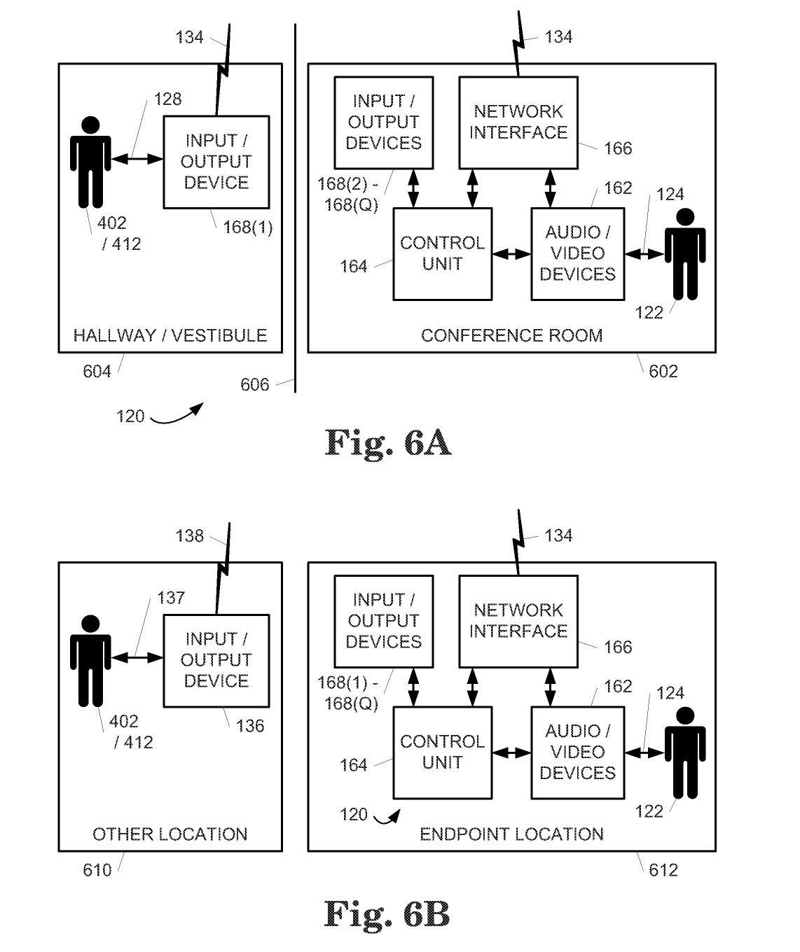

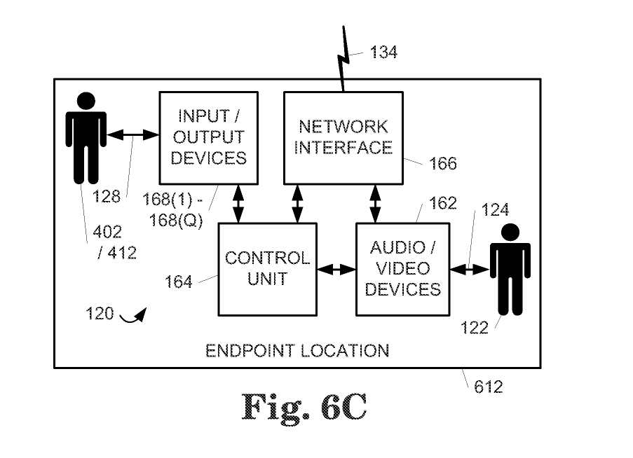

Person 402 communicates with event management system 110 using an input/output device 136A (i.e., a device not associated with an endpoint 120) or an input/output device 168A (i.e., a device associated with an endpoint 120) as indicated by an arrow 410. Similarly, person 412 communicates with event management system 110 using an input/output device 1368 (i.e., a device not associated with an endpoint 120) or an input/output device 168B (i.e., a device associated with an endpoint 120) as indicated by an arrow 420. Embodiments illustrating possible locations of devices 136A, 136B, 168A, and 168B are described below with reference to FIGS. 6A-6C.

FIG. 5 is a flow chart illustrating one embodiment of a method performed by an event management system 110. The embodiment of FIG. 5 will be described with reference to the embodiment shown in FIG. 4.

Referring to FIG. 5, event management system 110 receives information from person 402 as indicated in a block 502. The information may identify person 402 directly or indirectly (e.g., using a name, a event code, or other identifier), identify a location of person 402, or specify or request an action to be performed by event management system 110. Person 402 inputs the information into device 136A or 168A, and device 136A or 168A provides the information to event management system 110.

Event management system 110 associates person 402 with event 404 as indicated in a block 504. Event management system 110 associates person 402 with event 404 by determining a relationship between person 402 and event 404. The relationship may depend on an identity of person 402 as specified by the received information or, where person 402 uses device 168A which is associated with an endpoint 120, a location of the device 168A as specified by the received information.

In one embodiment, event management system 110 associates person 402 with event 404 by matching information received from person 402 (e.g., a name, an event code, or other identifier) with information in registered event specification 142(1). In another embodiment, event management system 110 associates person 402 with event 404 by matching location information that identifies a location of device 168A used by person 402 with location information in registered event specification 142(1) and/or event endpoint information and policies 146. In other embodiments, event management system 110 associates person 402 with event 404 in other suitable ways.

After associating person 402 with event 404, event management system 110 associates event 404 with at least event 414 as indicated by a block 506. In one embodiment, event management system 110 identifies an overlap of resources between events 404 and 414 using registered event specifications 142(1) and 142(s) and/or dynamic event context 144. The overlap of resources provides the basis for associating events 404 and 414 in one embodiment. In other embodiments, event management system 110 bases the association between events 404 and 414 on other suitable criteria using registered event specifications 142(1) and 142(s), dynamic event context 144, and/or event endpoint information and policies 146.

Event management system 110 determines whether to send a message to event 414 as indicated in a block 508. Event management system processes the information of block 502 and determines whether to send a message to event 414 using the information from person 402, registered event specifications 142(1) and 142(s), and/or event endpoint information and policies 146.

If event management system 110 decides to send a message to the event 414, event management system 110 provides the message to at least person 412 as indicated in a block 510. Event management system 110 may also provide the message to other attendees of or persons associated with event 414. Event management system 110 may select the message of block 510 in accordance with policies corresponding to the associated events as expressed in registered event specifications 142 and/or event endpoint information and policies 146 or default settings.

Device 136B or 1688 receives the message from event management system 110 and provides the message to at least person 412 and possibly other attendees of or persons associated with event 404. Person 412 may input a message or other information into device 136B or 168B in response to the message from event management system 110, and device 136B or 1688 provides the message or other information to event management system 110. Event management system 110 receives the message or other information from person 412.

Event management system 110 also determines whether to send a message to event 404 as indicated in a block 512. Event management system 110 processes the information of block 502 and any message or information received from person 412. Event management system 110 determines whether to send a message to event 404 using the information from person 402, any message or information received from person 412, registered event specifications 142(1) and 142(s), and/or event endpoint information and policies 146.

If event management system 110 decides to send a message to the event 404, event management system 110 provides the message to at least person 402 as indicated in a block 514. Event management system 110 may also provide the message to other attendees of or persons associated with event 404. Event management system 110 may select the message of block 514 in accordance with policies corresponding to the associated events as expressed in registered event specifications 142 and/or event endpoint information and policies 146 or default settings.

Event management system 110 may send the same message to event 404 as the message sent to event 414 in block 510 and may send the message both events 404 and 414 at the same time in one embodiment. In other embodiments, event management system 110 may send different messages to events 404 and 414 at the same or at different times.

Event management system 110 may repeat the functions of blocks 508, 510, 512, and 514 any suitable number of times to provide messages between associated events 404 and 414. At each step, event management system 110 selects appropriate messages to be provided based on information received from persons 402 and 404, registered event specifications 142(1) and 142(2), dynamic event context 144, and event endpoint information and policies 146. Event management system 110 may configure the messages in any suitable format and the format may correspond to a type of device with which event management system 110 is communicating. Examples of messages include text messages, email, status indicators, and messages that include a selectable function for use by person 402 or 412.

Persons 402 and 412 communicate with event management system 110 using respective input/output devices 136A or 168A and 1368 or 1688 from any suitable location. FIGS. 6A-6C are block diagrams illustrating embodiments of communicating with persons 402 and 412 who are associated with events. FIGS. 6A-6C illustrate at least three possible locations where persons 402 and 412 may provide messages to and receive messages from event management system 110.

In the embodiment of FIG. 6A, person 126 accesses an input/output device 168(1) (e.g., an interactive touchpoint or touchpad display) of an event endpoint 120 to communicate with event management system 110. In the embodiment of FIG. 5A, event endpoint 120 includes a conference room 602 and a hallway or vestibule 604 outside of conference room 602 as indicated by a barrier 606. Barrier 606 may be a wall, a door, a corridor, or other suitable physical structure or space that separates conference room 602 from hallway or vestibule 604. Input/output device 168(1) is located in hallway or vestibule 604 adjacent to conference room 602. Input/output device 168(1) is associated with event endpoint 120 with a physical connection (e.g., network connection 134) or other information that specifies the physical arrangement of input/output device 168(1) in event endpoint 120. Accordingly, person 126 may use input/output device 168(1) without visually or audibly interrupting an event taking place in conference room 602. Person 126, however, may opt to use input/output device 168(1), as indicated by arrow 128, in conjunction with event management system 110 to communicate with attendees 122 of an event in conference room 602. Communications to and from the event in conference room 602 may be included as part of media streams 124. Audio/video devices 162 of endpoint 120 that provide media streams 124 to attendees 122 and/or capture media streams 124 from attendees 122 are located inside conference room 602. Input/output device 168(1) is located outside conference room 602. Although other components of endpoint 120 are shown as being inside conference room 602 in the embodiment of FIG. 6A, some or all of these components may be located outside of or adjacent to conference room 602 in other embodiments (e.g., in a control room (not shown)).

In the embodiment of FIG. 6B, person 126 accesses an input/output device 136 (e.g., a mobile device) to communicate with event management system 110. In the embodiment of FIG. 6B, event endpoint 120 resides an endpoint location 612. Person 126 uses input/output device 168(1) from any other location 610 that may be remotely located from or in close proximity to endpoint location 612. Input/output device 136 has no physical relationship with endpoint location 612 or event endpoint 120 in the embodiment of FIG. 6B. Input/output device 136 may form a virtual association with endpoint location 612 or event endpoint 120 through communications with event management system 110. Person 126 may use input/output device 136, as indicated by arrow 137, in conjunction with event management system 110 to communicate with attendees 122 of an event in endpoint location 612. Communications to and from the event may be included as part of media streams 124.

In the embodiment of FIG. 6C, person 126 accesses any of input/output devices 168(1)-168(Q) (e.g., an interactive touchpoint or touchpad display) of event endpoint 120 to communicate with event management system 110. Person 126 may be one of the set of attendees 122 of an event at event endpoint 120. Person 126 uses an input/output device 168, as indicated by arrow 128, in conjunction with event management system 110 to communicate with other attendees 122 of an event at another event endpoint 120 (not shown in FIG. 6C). The endpoint 120 where person 126 is located may be remotely located from or in close proximity to the other endpoint 120. Communications to and from the event may be included as part of media streams 124 at the other event endpoint 120.

Event management system 110 may provide any suitable type of messages between events 404 and 414. For example, event management system 110 may provide persons 402 and/or 412 with messages that describe the status of event 404, event 414, and/or other events, messages from parties associated with other events, or messages with functions that allow persons 402 and/or 412 to cause messages to be sent to other events. The messages may begin in response to person 402 or 412 checking in for event 404 or 414, respectively, or in response to other actions, messages, or states detected by event management system 110.

In examples where person 402 is an attendee 122 of an in progress event, person 402 may communicate with event management system 110 to cause status messages regarding a scheduled event 414 to be provided to person 402. Person 402 may also cause messages to be provided to the scheduled event 414 such as a notice of or a request for an extension of time. Person 402 may also respond to messages from event management system. 110 that are initiated by person 412 of the scheduled event 414 to effectively negotiate for resources with the scheduled event 414.

In examples where person 402 is a scheduled attendee 122 of a scheduled event, person 402 may communicate with event management system 110 to check in for the scheduled event or cause status messages regarding an in progress event 414 to be provided to person 402. Person 402 may also cause messages to be provided to the in progress event 414 such as a request for use of a resource. Person 402 may also respond to messages from event management system 110 that are initiated by person 412 of the in progress event 414 to effectively negotiate for resources with the in progress event 414.

In examples where event management system 110 provides a message to all attendees 122 of event 404 or 414, all attendees 122 of event 404 or 414 may become aware of a situation involving their event simultaneously and can collectively decide how to proceed.

The messages provided by event management system 110 may be selected in response to information in registered event specifications 142(1) and 142(2) and/or event endpoint information and policies 146.

A registered event specifications 142 may indicate a priority of an event, for example. Event management system 110 may send messages to an event only if the event is not a high priority event as indicated by registered event specification.

As another example, event endpoint information and policies 146 may direct event management system 110 to notify an event anytime that a resource overlap that involves the event is detected.

Registered event specifications 142 and/or event endpoint information and policies 146 may also indicate that one or more events are notto be disturbed (i.e., no messages are to be sent during the event). If so, then event management system 110 does not send a message to the event.

Event management system 110 may also select messages based on individualized access privileges of persons associated with events. For example, event management system 110 may be configured to provide messages only to attendees 122 of events that are listed in registered event specifications 142. As another example, event management system 110 may be configured to only allow a person associated with one event to send a message to another event if the person is an organizer or administrator of the event.

In a further example, event management system 110 may initiate a staged ending of an in progress event in response to a threshold proportion of attendees 122 of a scheduled event checking in for the scheduled event.

Once any resource overlap with the events is resolved using the above embodiments, event management system 110 may initiate one or more of the events by allocating the set of event endpoints 120 and any other resources for the events.

In the above embodiments, event management system 110 may include any suitable combination of hardware and software components. In one embodiment, event management system 110 includes one or more programs that is stored in any suitable type, number, and/or combination of portable or non-portable storage media (not shown) within or otherwise accessible to event management system 110. The programs are accessible to and executable by any suitable type, number, and/or combination of processors (not shown) in event management system 110 to perform the functions described above.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the optical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited by the claims and the equivalents thereof.

What is claimed is:

1. A method performed by an event management system, the method comprising:
in response to receiving first information from a first person, associating the first person with a first event that is configured to provide a first set of media streams at a first set of event endpoints using the first information; and
providing a first message to a second person associated with a second event that is configured to provide a second set of media streams at a second set of event endpoints wherein the second event is associated with the first event.

2. The method of claim 1 wherein the first information identifies the first person.

3. The method of claim 1 wherein the first information identifies a location of the first person.

4. The method of claim 1 further comprising:
selecting the first message in accordance with a policy associated with the first event.

5. The method of claim 1 further comprising:
selecting the first message in accordance with a policy associated with the second event.

6. The method of claim 1 further comprising:
associating the first event with the second event using first and second registered event specifications for the first and the second events, respectively.

7. The method of claim 1 further comprising:
providing a second message associated with the second event to the first person.

8. The method of claim 1 further comprising:
receiving a response to the first message from the second event; and
providing the second message to the first person in accordance with the response.

9. The method of claim 1 wherein the first event overlaps with the second event.

10. A system comprising:
a network interface configured to connect to a network; and
an event management system including first and second registered event specifications for first and second events, respectively, that specify first and second sets of event endpoints, respectively, for providing first and second sets of media streams, respectively, to first and second sets of attendees, respectively;
wherein the event management system is configured to receive first information from a first person associated with the first event using the network interface, and wherein the event management system is configured to provide a first message to a second person associated with the second event in accordance with the first information using the network interface.

11. The system of claim 10 wherein the first event is a scheduled event, and wherein the second event is an in progress event.

12. The system of claim 10 wherein the first event is an in progress event, and wherein the second event is a scheduled event.

13. The system of claim 10 wherein the first message is configured to provide at least one of second information that identifies a status of the first event, third information that identifies a status of the second event, a notification of overlap between the first and the second events, and a selectable function to the second person.

14. The system of claim 10 wherein the event management system is configured to provide a second message associated with the second event to the first person prior to receiving the first information using the network interface.

15. The system of claim 10 wherein the event management system is configured to provide a second message associated with the second event to the first person subsequent to receiving the first information using the network interface.

16. A program product comprising:
a program executable by a processor for causing the processor to:
receive information from a first person;
associate the first person with a first event that is configured to provide a first set of media streams at a first set of event endpoints using the first information; and
provide a first message corresponding to the information to a second person associated with a second event that is configured to provide a second set of media streams at a second set of event endpoints;
a medium that stores the program so that the program is accessible by the processor.

17. The program product of claim 16 wherein the program is executable by the processor for causing the processor to:
associate the first person with the first event using a registered event specification for the first event.

18. The program product of claim 16 wherein the program is executable by the processor for causing the processor to:
associate the first person with the first event using event endpoint information.

19. The program product of claim 16 wherein the program is executable by the processor for causing the processor to:
identify a status of each of the first and the second events using dynamic event context information.

20. The program product of claim 16 wherein the program is executable by the processor for causing the processor to:
provide a second message associated with the second event to the first person.
